(19) United States
(12) Patent Application Publication
(10) Pub. No.: US 2001/0017532 A1
(43) Pub. Date: Aug. 30, 2001

(54) Battery changing method during call processing in wireless telephone set

(75) Inventor: Jay-Hee Han, Seoul (KR)

Correspondence Address: Paul J. Farrell, Dilworth & Barrese, LLP, 333 Earle Ovington Blvd., Uniondale, NY, 11553, US

(73) Assignee: Samsung Electronics Co., Ltd.

(21) Appl. No.: 09/729,494

(22) Filed: Dec. 4, 2000

(30) Foreign Application Priority Data
Dec. 2, 1999 (KR) 1999-54381

(51) Int. Cl. H02J 7/00

(52) U.S. Cl. 320/114

(57) ABSTRACT

Disclosed is a battery changing method during processing of a call without interrupting a talking path in a wireless telephone set having a supplementary battery and a main battery. In the battery changing method according to the invention, it is detected whether or not a capacity of the battery is less than a predetermined value during the call processing. If in the affirmative, it is detected whether or not a mode set key requiring a battery change is inputted by a user. If in the affirmative, electric power of the wireless telephone set is switched to the supplementary battery and a power saving mode is operated to transmit messages for maintaining the wireless link. It is then detected whether or not a key requesting a return to a normal mode is inputted during the power saving mode. If in the affirmative, electric power of the wireless telephone set is switched back to the main battery and a normal mode is resumed.

### PRIORITY

This application claims priority to an application entitled “Battery Changing Method During Call Processing in Wireless Telephone Set” filed with the Korean Industrial Property Office on Dec. 2, 1999 and assigned Ser. No. 1999-54381, the contents of which is hereby incorporated by reference.

### BACKGROUND OF THE INVENTION

1. Field of the Invention

The present invention relates generally to a method of controlling a wireless telephone set, and in particular, to a battery changing method during processing of a call in a wireless telephone set.

2. Description of the Related Art

In general, the conventional wireless telephone set is designed to operate by means of batteries. Therefore, if a battery is exhausted, it is necessary to change or recharge the battery.

However, if the battery is exhausted during processing of a call, a user needs to undergo complicated procedures such as interrupting a talking path, changing the battery, turning on the electric power of the wireless telephone set and then making a phone call again.

To address the above problems, technology has been developed whereby a supplementary battery is built into the wireless telephone set and a power supply is switched to the supplementary battery when an outer packaging battery is exhausted. However, if the supplementary battery is used during processing of a call when a maximum electric power is required in the wireless telephone set, durability of the built-in supplementary battery is curtailed. Therefore, a battery of greater capacity is required to maintain the talking path during the call when changing from the exhausted battery. Despite the developed technology in the field of batteries, however, problems still arise, i.e., as the greater the capacity of a battery becomes, the larger its size and the heavier its weight become. As a consequence, the wireless telephone set becomes larger and heavier, thereby impeding the portability of the wireless telephone set, which is a most sensitive point. Thus, increasing the capacity of batteries is limited.

### SUMMARY OF THE INVENTION

It is, therefore, an object of the present invention to provide a method for changing a battery during call processing without interrupting a talking path in a wireless telephone set which houses a small-sized supplementary battery.

It is another object of the present invention to provide a method for allotting a user sufficient time to change the battery during call processing by using the small-sized supplementary battery.

It is still another object of the present invention to provide a method for changing the battery and maintaining the talking path by utilizing the minimum electric power during call processing.

To achieve the above objects, there is provided a battery changing method during processing of a call without interrupting the talking path in a wireless telephone set, where the telephone set houses a main battery and a supplementary battery. The battery changing method according to the present invention comprises the steps of: detecting whether or not the capacity of the main battery is less than a predetermined value during processing of a call; if in the affirmative, detecting whether or not a mode set key for changing the battery is inputted by the user; if in the affirmative, switching the electric power of the wireless telephone set to the supplementary battery; entering a power saving mode for transmitting messages to maintain a wireless link; detecting whether or not a key requesting a return to a normal mode is inputted during operation in the power saving mode; and if in the affirmative, switching the electric power of the wireless telephone set to the main battery.

### BRIEF DESCRIPTION OF THE DRAWINGS

The above and other objects, features and advantages of the present invention will become more apparent from the following detailed description when taken in conjunction with the accompanying drawings, in which:

FIG. 1 is a schematic block diagram illustrating a wireless telephone set according to a preferred embodiment of the present invention;

FIG. 2 is a flow chart illustrating a control process for a battery change during processing of a call according to a preferred embodiment of the present invention; and

FIG. 3 is a flow chart illustrating a control process for a battery change during processing of a call according to another preferred embodiment of the present invention.

### DETAILED DESCRIPTION OF THE PREFERRED EMBODIMENT

A preferred embodiment of the present invention will be described herein below with reference to the accompanying drawings. While the invention has been shown and described with reference to certain preferred embodiments thereof, it will be understood by those skilled in the art that various changes in form and details may be made therein without departing from the spirit and scope of the invention as defined by the appended claims. In the following description, well-known functions or constructions are not described in detail since they would obscure the invention in unnecessary detail.

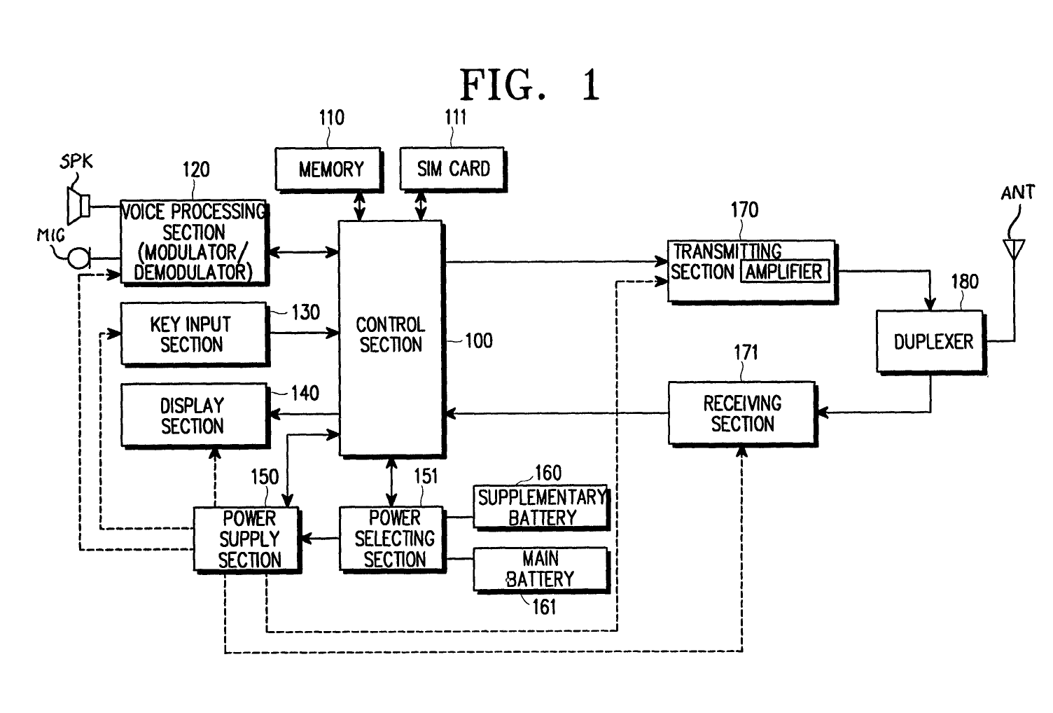

FIG. 1 is a schematic block diagram illustrating a wireless telephone set according to a preferred embodiment of the present invention. Referring to FIG. 1, a control section 100 controls overall operations of the wireless telephone set. A key input section 130, including a plurality of numerical and alphabetical keys, function keys (FCN), storage keys (STO), etc., generates key data with respect to the keys. A memory 110 temporarily stores data generated during operation of a predetermined operational program. A display section 140 displays a plurality of data, including data on the operation and data inputted by the key input section 130. A transmitting section 170, including an amplifier for amplifying signals to be transmitted to a station, filters and amplifies the signals. A receiving section 171 amplifies and filters signals received through an antenna (ANT) and down-converts the signals into base band signals. A voice processing section 120 digitalizes voice inputted through a microphone (MIC) under the control of the control section 100 and demodulates voice data inputted by the receiving section 171, and then outputs the same through a speaker (SPK). The voice processing section 120 includes a modulator and a demodulator for performing the above operation. In general, the modulator and the demodulator are referred to as a coder and a decoder (CODEC), respectively. A duplexer 180 connects the antenna to the transmitting section 170 and the receiving section 171. A SIM card 111 stores information on a subscriber and the wireless telephone set as well as other various information necessary for connecting a call.

A power supply section 150 supplies or interrupts the electric power to each sections of the wireless telephone set under the control of the control section. A power selecting section 151 measures output voltages of a supplementary battery 160 and a main battery 161, detects whether or not the main battery 161 is attached/detached, and then switches the batteries 160, 161 so as to be connected to the power supply section under the control of the control section 100.

If not fully charged, the supplementary battery 160 is charged from the main battery 161 during changing of the main battery 161. If the supplementary battery 160 is not fully charged during the battery charging, not only the main battery 161 but also the supplementary battery 160 are fully charged by means of a charger. In the course of the battery charging by means of the charger, the supplementary battery 160 may be charged through the same charging route as the main battery 161, or may be directly charged through an external port. Here, the supplementary battery may be replaced by an ordinary battery.

The wireless telephone set as described above and a wireless telephone set to be described herein below are used for a global system for mobile (GSM), a code division multiple access (CDMA), a mobile terminal equipment for next generation (IMT 2000) or a mobile phone using satellites, and thus is not restricted to a particular system.

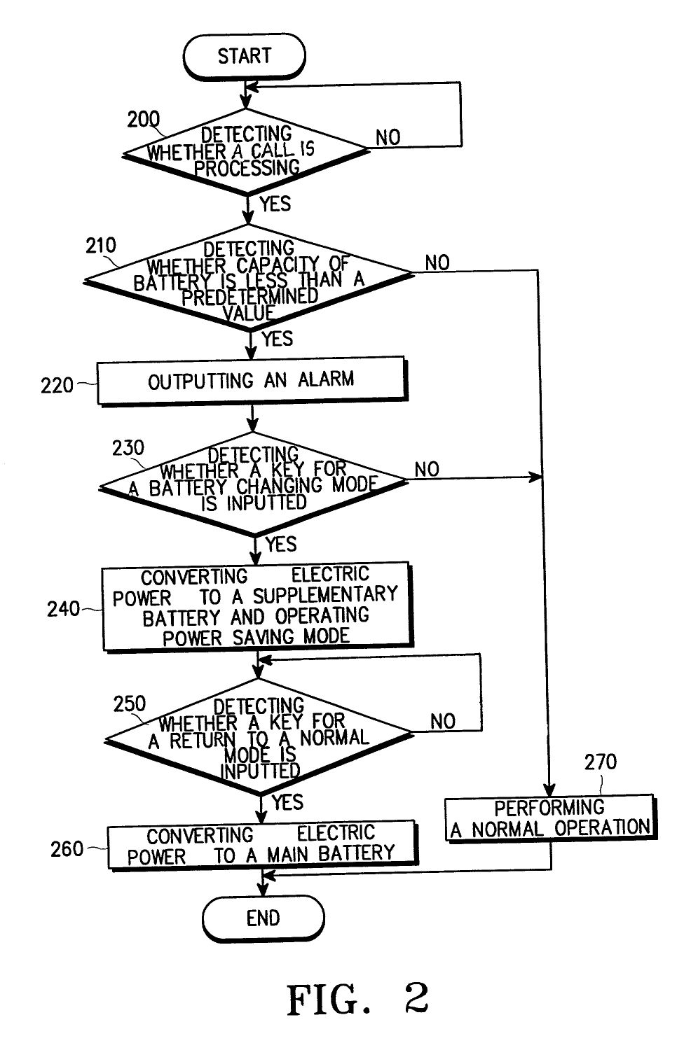

An operation of the preferred embodiment of the present invention will now be described with reference to FIGS. 1 and 2.

The control section 100 detects whether or not the wireless telephone set is processing a call in step 200. If it is, the power selecting section 151 detects whether or not the capacity of the main battery 161 is less than a predetermined value in step 210. If so, at step 220, the control section 100 outputs alarm or character messages through a speaker (SPK) in step 220 to inform the user that the capacity of the main battery 161 is almost exhausted. If not, the process proceeds to step 270 and normal operations are performed.

The control section 100 then detects whether or not the key data inputted through the key input section 130 by a user requires an operation of a battery change mode in step 230. Step 240 is proceeded with in the affirmative, whereas step 270 is proceeded with in the negative, and normal operations are performed.

The control section 100 switches the electric power of the wireless telephone set from the main battery 161 to the supplementary battery 160 in step 240. In other words, a switching operation of the power selecting section 151 switches the electric power path directed to the power supply section 150 to the supplementary section 160. Thus, the wireless telephone set performs a power saving mode.

The following is a detailed description of the power saving mode.

If the terminal is in the power saving mode, the control section 100 controls the power supply section 150 so as to turn off the electric power supplied to the display section 140, the receiving section 171 and the voice processing section 120. Here, the key input section 130 may turn off the electric power supplied to all sections, excluding particular keys necessary for returning to a normal mode in the near future. When turning off the electric power supplied to the voice processing section 120, only the modulator and the demodulator in the voice processing section 120 may be turned off.

If a person using a GSM wireless telephone set does not speak, the system transmits a silence indicator only to the station. In that case, the amount of transmitted data and transmitting band width decreases, and the volume of a transmission frame is also decreased, thereby reducing consumption of the electric power. According to a preferred embodiment of the present invention, the wireless telephone set transmits a silence indicator in order to save consumption of the electric power during operation of the power saving mode, even if a user speaks on the phone. After transmission of the silence indicator, the wireless telephone set sends messages to indicate that a dumb condition, i.e., a discontinuous transmission (DTX), continues. In other words, the wireless telephone set transmits the silence indicator so as to inform of the dumb condition and transmits the DTX so as to inform of continuation of the dumb condition. In that case, the volume of the transmission frame can be reduced by up to 85%.

The electric power transmitted by the GSM wireless telephone set is determined based on a power level required for the wireless telephone set after the station measures strength of signals transmitted by the wireless telephone set to the station. In other words, if the wireless telephone set becomes distant from the station and the signals received by the station become diminished, the station transmits messages to the wireless telephone set to request an elevation of the transmitted power level. The power level here means a power level recommended by the station in order to maintain communication with the wireless telephone set. The specification of the GSM requires that the station maintain a demodulation or a link even if the power level received from the wireless telephone set is about two grades (6 dB) lower than the power recommended power level. Therefore, the link can be maintained without any strain even if the wireless telephone set transmits the electric power two grades (6 dB) lower than the power level recommended by the station. According to a preferred embodiment of the present invention, the power level of the signals to be transmitted to the station during the power saving mode is transmitted on conditions of two grades lower than the power level recommended by the station before operating the power saving mode. For example, if there is a request for transmission with an electric power of 10 dB, the transmitted power level can be lowered to a minimum level of 4 dB. In that case, the transmission power can be saved 75% in comparison with the usual case.

According to the conventional GSM method, the wireless telephone set periodically reports diverse information in order to maintain the link with the station. If the station fails to generate reports for more than a predetermined number of reports, the link with the wireless telephone set is considered to have been terminated. During the power saving mode according to the present invention, the reports are generated with a minimum cycle necessary for maintaining the link with the station and the wireless telephone set. That is to say, during the power saving mode, the reports under the control of the control section 100 should be made to have a minimum cycle so as for the link not to be terminated. According to the conventional GSM method, if the periodic report messages are not received more than three times, the link with the wireless telephone set is terminated. By contrast, during the power saving mode of the present invention, the control section 100 can transmit report messages periodically. While the link is maintained in the above case, the number of reporting decreases, thereby reducing consumption of the electric power. The following is an example of the cycle of the reports.

TABLE 1

| | 1 | 2 | 3 | 4 | 5 | 6 | 7 | 8 | 9 | 10 | 11 | 12 |
|---|---|---|---|---|---|---|---|---|---|---|---|---|
| Conventional | ◯ | ◯ | ◯ | ◯ | ◯ | ◯ | ◯ | ◯ | ◯ | ◯ | ◯ | ◯ |
| | ◯ | X | ◯ | X | ◯ | X | ◯ | X | ◯ | X | ◯ | X |
| Example 2 | ◯ | X | X | ◯ | X | X | ◯ | X | X | ◯ | X | X |
| Example 3 | ◯ | X | ◯ | X | X | ◯ | X | ◯ | X | X | ◯ | X |
| Example 4 | ◯ | ◯ | X | ◯ | ◯ | X | ◯ | ◯ | X | ◯ | ◯ | X |
| Example 5 | ◯ | ◯ | X | X | ◯ | ◯ | X | X | ◯ | ◯ | X | X |

In the above Table 1, “o” represents transmission of the report messages, and “x” represents non-transmission of the report messages. As shown in the Table 1, the report messages are transmitted to the extent of avoiding termination of the link between the wireless telephone set and the station. If the number of received report messages are adjusted to the above level, the transmission frame can be reduced by 7%.

The reports include data obtained through a measurement reporting, which includes a step of measuring and transmitting various broadcast information received by the wireless telephone set. Here, the measured data includes strength of signals received by a neighboring station or may include information on the station. However, this measurement can not be carried out since the power supply to the receiving section 171 has been turned off during power saving mode as stated above. Since the above information should be transmitted to the station, however, the information measured and transmitted to the station before operation of the power saving mode is continuously used, according to the preferred embodiment of the present invention.

In general, while the wireless telephone set is used for communication between parties, polling is utilized for operating data receipt/transmission with various peripheral devices (an ear microphone, a data link cable, a charger, etc.). However, polling is also not carried out during the power saving mode according to a preferred embodiment of the present invention.

Table 2 below shows a simple operation of the telephone set in the power saving mode.

TABLE 2

| Method | Contents | Reduction effect |
|---|---|---|
| Transmitted power | Transmitted level two | 75% of transmission |
| Level | grades lower than the | power |
| | recommended power level | |
| Discontinuous | Cut-off of transmission | 85% of transmission |
| transmission | | frame |
| Measurement | Not measured | All measurement |
| | | Frame |
| Report | Skip a number of | 7% of transmission |
| | Transmissions | frame |
| Power-off | Display section, | |
| | receiving section, voice | |
| | processing section | |
| Polling | Interruption of polling | |

As shown above, during the power saving mode according to the preferred embodiment of the present invention, a minimum of the possible operations of the telephone set are performed to maintain the link with the station while other operations are all interrupted. In other words, the power supply to all sections except the transmitting section 170 and the control section 100 are turned off to save power.

During the power saving mode, other operations can be performed as deemed necessary in addition to the aforementioned operations. Preferably, however, all operations are interrupted or powered off except the operation required to maintain the link with the station in order to save power.

Referring back to FIG. 2, at step 250 the control section 100 detects whether or not a key requesting a return to the normal mode is inputted from the key input section 130 by a user. In other words, the control section 100 detects whether or not the user has completed a change from the original main battery to another charged main battery and then inputs a key to return to the normal mode. If in the affirmative, the process proceeds to step 260. If in the negative, the process returns to step 250. At step 260, the control section 100 controls the power supply section 150 and the power selecting section 151, switches the electric power to the main battery, and returns to the normal mode. That is to say, the operation interrupted by the power saving mode is re-performed and the electric power is supplied to the various sections which were turned off. Further, if the capacity of the main battery is greater than the predetermined value, the supplementary battery 160 is charged by using the electric power supply of the main battery 161. That is, the supplementary battery 160 should always remain fully charged.

If the electric power is supplied to the receiving section 171, an operation is restored to measure information on neighboring stations as well as to measure the strength of the received electric power, after suspension of the same during the power saving mode described above. Further, the electric power is also supplied to the voice processing section 120, which performs an output of the received voice data and decryption of the voice data inputted through a microphone. The normal transmission cycle of the reports is restored, and the electric power is also supplied to the key input section 130 and the display section 140. Since normal mode is basically operation of the wireless telephone set under normal conditions, no further description will be provided herein.

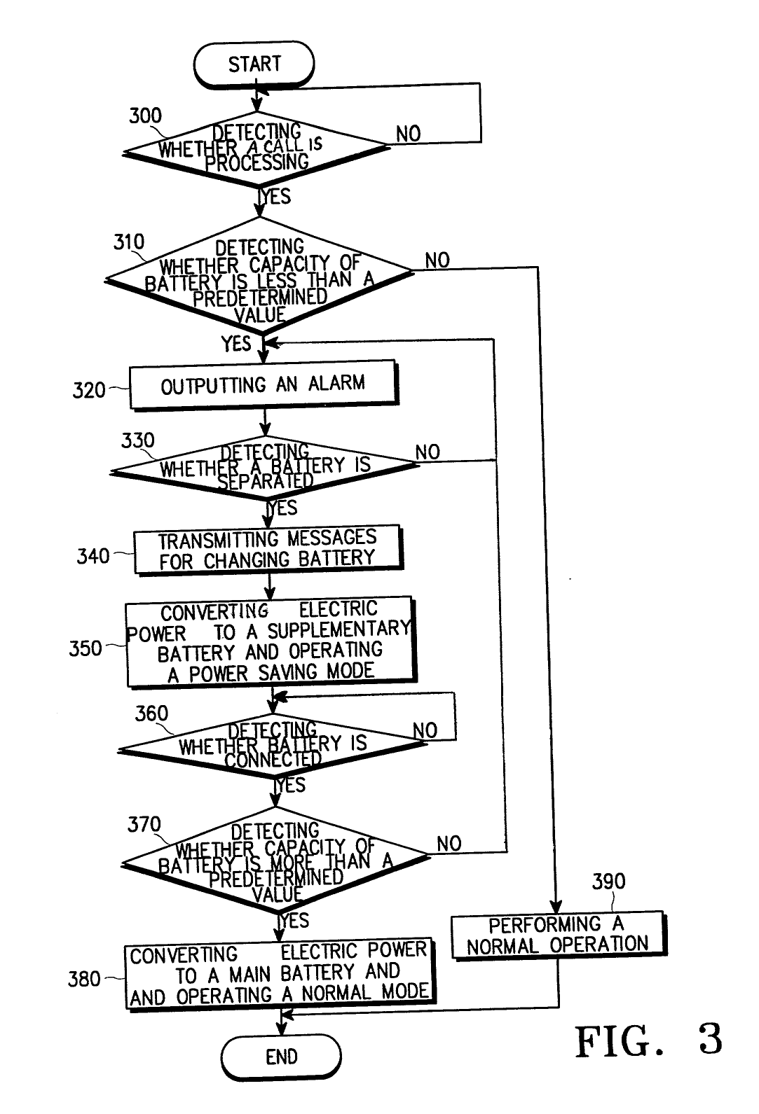

An operation of another preferred embodiment of the present invention will now be described with reference to FIGS. 1 and 3.

FIG. 3 shows operation of the power saving mode according to another preferred embodiment of the present invention. Control section 100 detects whether or not a user is communicating on the phone in step 300. If in the affirmative, the control section 100 detects whether or not the capacity of a main battery 161 is less than a predetermined value utilizing power selecting section 151 in step 310. If in the affirmative, the process proceeds to step 320. If in the negative, that is, if the battery capacity is above the predetermined value, the process proceeds to step 390 and the telephone set performs normal operations.

If the battery capacity is below the predetermined value, control section 100 outputs an alarm in step 320. The alarm indicates, by a voice message generated by a voice processing section 120 through the speaker (SPK), that the capacity of the battery is insufficient, and that a battery change is required. Here, the voice message may be data already stored in a voice memory region of memory 110. Of course, the alarm messages may also be outputted in characters by the display section 140. Further, the control section 100 transmits messages to request a communicating partner on the call to wait since the user is changing the battery.

The control section 100 detects whether or not the main battery 161 has been detached by means of the power selecting section 151 in step 330. If main battery 161 has been detached, the process proceeds to step 340. The control section 100 outputs messages indicating the battery is being changed through the display section 140 and the voice processing section 120 in step 340. If the battery has not been changed, the process returns to step 320 and the control section 100 continues to generate an alarm.

The control section 100 switches the electric power of the wireless telephone set from the main battery 161 to the supplementary battery 160 in step 350. The control section 100 also enters the power saving mode. The power saving mode operates as stated above, and thus no further description will be made herein in detail.

The control section 100 then detects whether or not the main battery 161 is re-connected by the power selecting section 151 in step 360. If it has been, the process proceeds to step 370. If the battery 161 has not been reconnected, the process returns to step 360.

If the battery 161 has been reconnected, the control section 100 then detects whether or not the capacity of the main battery 161 is greater than the predetermined value by means of the power selecting section 151 in step 370. If in the affirmative, the process proceeds to step 380. If it is not, the process returns to step 320.

At step 380, the control section 100 switches the electric power of the wireless telephone set to the main battery 161 by means of the power selecting section 151 and power supply section 150, and returns to a normal mode.

In comparison with FIG. 2, FIG. 3 shows that an operation of the power saving mode for a battery change is automatically performed without input of any keys.

To summarize the present invention, if the capacity of the battery is less than a predetermined value during processing of a call, the telephone set enters power saving mode so as to reduce and minimize power consumption. Once the user changes the battery, the electric power is connected to the charged battery, thereby enabling the user to have a continuous communication. Therefore, the battery can be changed during processing of a call without interrupting the talking path. Further, the user is allotted sufficient time for the battery change while maintaining the link and minimizing power consumption.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A battery changing method during processing of a call in a wireless telephone set, the telephone set having a supplementary battery and a main battery, the method comprising the steps of:
detecting whether or not a capacity of the main battery is less than a predetermined value during the call processing;
if the capacity is less, detecting whether or not a mode set key is inputted to request a battery change by a user;
if the mode set key is input, switching electric power from the main battery to the supplementary battery and entering a power saving mode;
transmitting messages to maintain a wireless link;
detecting whether or not a key requesting a return to a normal mode is inputted during the power saving mode; and
if the request key is input, switching electric power from the supplementary battery back to the main battery and entering the normal mode.

2. The battery changing method of claim 1, wherein the step of entering the power saving mode comprises turning off an electric power supply to a receiving section of the wireless telephone set.

3. The battery changing method of claim 1, wherein the step of entering the power saving mode comprises transmitting messages periodically from the wireless telephone set to a station to maintain the wireless link with the station at minimum intervals necessary to maintain the link.

4. The battery changing method of claim 1, wherein the step of entering the power saving mode comprises transmitting messages to a station to indicate that the wireless telephone set is under dumb condition.

5. The battery changing method of claim 1, wherein the step of entering the power saving mode comprises reducing a power level of signals transmitted to a station by the wireless telephone set to a minimum level necessary for maintaining the wireless link with the station and transmitting the same to the station.

6. The battery changing method of claim 1, wherein the step of entering the power saving mode further comprises a step of turning off electric power to a modulator or a demodulator for outputting or inputting voice of the wireless telephone set, respectively.

7. The battery changing method of claim 1, wherein the step of entering the power saving mode further comprises the step of reporting to a station by the wireless telephone set a received power level that was transmitted before entering the power saving mode.

8. The battery changing method of claim 1, wherein the step of entering the power saving mode further comprises a step of one of demodulating received voice data or measuring the power level of a neighboring station, or not demodulating or receiving recorded broadcast information of the station by the wireless telephone set.

9. The battery changing method of claim 1, wherein the step of entering the power saving mode further comprises a step of turning off electric power to a display section of the wireless telephone set.

10. The battery changing method of claim 1, wherein the step of entering the power saving mode comprises discontinuing polling of annexed devices mountable to or installable within the wireless telephone set.

11. The battery changing method of claim 1, wherein the step of entering the normal mode resumes an operation suspended or changed during operation in the power saving mode.

12. The battery changing method of claim 1, further comprising the step of charging the supplementary battery from one of the main battery or an external charger if the supplementary battery has not been fully charged during charging or changing the main battery.

13. A battery changing method during processing of a call without interrupting a talking path in a wireless telephone set having a supplementary battery and a main battery, the battery changing method comprising the steps of:
detecting whether or not a capacity of the main battery is less than a predetermined value during the call processing;
if the capacity is less, detecting whether or not the main battery has been detached from the wireless telephone set;
if the main battery has been detached, switching electric power of the telephone set to the supplementary battery and operating in a power saving mode; and
operating in a normal mode after the main battery is changed during the power saving mode.

14. The battery changing method of claim 13, wherein the step of operating in the power saving mode comprises turning off electric power to a receiving section of the telephone set.

15. The battery changing method of claim 13, wherein the step of operating in the power saving mode comprises transmitting messages, which are periodically transmitted by the wireless telephone set to a station, to maintain a wireless link with the station, at minimum intervals necessary for maintaining the link.

16. The battery changing method of claim 13, wherein the step of operating in the power saving mode comprises transmitting messages to a station to indicate that the wireless telephone set is under a dumb condition.

17. The battery changing method of claim 13, wherein the step of operating in the power saving mode comprises a reducing a power level of signals transmitted to a station by the wireless telephone set to a minimum level necessary for maintaining a wireless link with the station, and transmitting the same to the station.

18. The battery changing method of claim 13, wherein the step of operating in the power saving mode comprises turning off a modulator or a demodulator of the telephone set for outputting or inputting of a voice in the wireless telephone set.

19. The battery changing method of claim 13, further comprising the step of reporting to a station by the wireless telephone set a received power level, the transmitted power level being the received power level transmitted before operating in the power saving mode.

20. The battery changing method of claim 1, wherein the step of operating in the power saving mode comprises one of demodulating a received voice data or measuring the power level of a neighboring station, or not demodulating or receiving recorded broadcast information of the station by the wireless telephone set.

21. The battery changing method of claim 13, wherein the step of operating in the power saving mode to further comprises the step of discontinuing polling of annexed devices mountable to or installable within the wireless telephone set.

22. The battery changing method of claim 13, further comprising the steps of:
outputting alarm messages if the capacity of the main battery is less than the predetermined value; and
transmitting messages to a communicating partner of the telephone set user to indicate that the battery is being changed if the main battery has been detached from the wireless telephone set.

23. The battery changing method of claim 13, wherein the step of operating in the normal mode continues if the capacity of the changed main battery is greater than a predetermined value.

24. The battery changing method of claim 13, further comprises charging the supplementary battery from one of the main battery or an external charger if the supplementary battery has not been fully charged during charging or changing the main battery.

25. A battery changing method during processing of a call without interrupting a talking path in a wireless telephone set of a GSM communication system, the telephone set having a supplementary battery and a main battery, the battery changing method comprising the steps of:
detecting whether or not a capacity of the main battery is less than a predetermined value during the call processing;
if the capacity is less, switching electric power of the wireless telephone set from the main battery to the supplementary battery and operating the telephone set in a power saving mode;
changing the main battery to a second main battery; and
operating the telephone set in a normal mode after the main battery is changed during the call processing.

26. The battery changing method of claim 25, wherein the step of operating in the power saving mode comprises turning off electric power supply to a receiving section of the telephone set.

27. The battery changing method of claim 25, wherein the step of operating in the power saving mode comprises transmitting messages, which are periodically transmitted to a station in order to maintain a wireless link between the wireless telephone set and the station at predetermined intervals.

28. The battery changing method of claim 25, wherein the step of operating in the power saving mode comprises transmitting silence messages to indicate that the wireless telephone set is under a dumb condition and operating in a discontinuous transmission mode so as not to transmit voice data to a station.

29. The battery changing method of claim 25, wherein the step of operating in the power saving mode comprises adjusting a power level of signals transmitted by the wireless telephone set to a station to be higher than a power level in the normal mode of operation, which is two grades lower than the recommended power level in normal mode to maintain the wireless link with the station.

30. The battery changing method of claim 25, wherein the step of operating in the power saving mode comprises turning off a modulator or a demodulator of the telephone set for outputting or inputting a voice.

31. The battery changing method of claim 25, further comprising the step of reporting to a station by the wireless telephone set a received power level which is the received power level transmitted before operation in the power saving mode.

32. The battery changing method of claim 25, wherein the step of operating in the power saving mode comprises one of discontinuing demodulation of received voice data or discontinuing measurement of a power level of a neighboring station, or one of discontinuing demodulation or reception of recorded broadcast information of the station by the wireless telephone set.

33. The battery changing method of claim 25, wherein the step of operating in the power saving mode comprises discontinuing polling of one of a charger, an earphone, a microphone or a data link cable device mountable to or installable within the wireless telephone set.

34. The battery changing method of claim 25, further comprising the step of charging the supplementary battery from one of the main battery or an external charger if the supplementary battery has not been fully charged during charging or changing of the main battery.
